(19) United States
(12) Patent Application Publication
(10) Pub. No.: US 2007/0195247 A1
(43) Pub. Date: Aug. 23, 2007

(54) Complementary anti-parallel substrate alignment in vertically aligned nematic liquid crystal displays

(76) Inventor: James Anderson, Cuyahoga Falls, OH (US)

Correspondence Address: ROETZEL & ANDRESS, 1375 EAST 9TH STREET, CLEVELAND, OH, 44114, US

(21) Appl. No.: 11/360,367

(22) Filed: Feb. 23, 2006

(51) Int. Cl. G02F 1/1337

(52) U.S. Cl. 349/130

(57) ABSTRACT

Liquid crystal substrates have alignment layers with complementary anti-parallel alignment angles to diminish performance degradation from non-uniformity, and improve performance and simplify manufacturing methods. Methods of forming vertically-aligned nematic liquid-crystal display cells with complementary angled alignment layers are described. A first alignment layer defines first-substrate pre-tilt angles between first-substrate normal and molecules of the liquid-crystal fluid located adjacent to the interior surface of the first substrate, and a second alignment layer defines second-substrate pre-tilt angles between second-substrate normal and molecules of the liquid-crystal fluid located adjacent to the interior surface of the second substrate. Average values of the first-substrate and second-substrate pre-tilt angles located along common axes that extend normal to the first and second substrates are made substantially uniform by the complementary pre-tilt angles of the first and second substrates.

### FIELD OF THE INVENTION

The invention relates generally to liquid-crystal displays (LCD), including vertically aligned nematic (VAN) LCDs and applicable methods of manufacture.

### BACKGROUND OF THE INVENTION

The uniformity of the pre-tilt alignment layer for VAN mode cells, i.e. the angle between the substrate plane and the average molecular orientation at the surface, is critical to the performance of the cell. The performance of the VAN mode, which can be better than conventional TN modes, suffers when the pre-tilt angle is not optimal. If the pre-tilt angle (also referred to simply as “pre-tilt”) varies across a substrate, performance can vary from one device to another or within a single device. Methods for manufacturing VAN mode LCDs with inorganic alignment layers are well known. In some of these methods, the resulting uniformity of the molecular alignment across a substrate is unsatisfactory. Because the performance of this mode is so dependent upon pre-tilt alignment, much research has been done to make this alignment more uniform, mostly focusing on coating or processing of the alignment layer surfaces.

Without an electric field between the electrodes, the liquid-crystal molecules are oriented vertically and almost perpendicular to the substrate glass plates. An alignment layer is provided to the glass plates to align the liquid-crystal molecules nearest to the glass plates at a small angle relative to glass-plate normal, to ensure that the liquid-crystal molecules uniformly fall in a desired direction. Linearly-polarized light transmitted through the LCD will experience only a minimal birefringence due to the vertical orientation of the liquid-crystal molecules, resulting in a very small change in the polarization state of light and thus a very dark image.

Conventional processes for manufacturing VAN LCDs involve the oblique evaporation of an alignment-layer material such as silicon monoxide (“SiO”) onto the surfaces of the glass substrates. Each glass plate that will form a substrate of the VAN LCD is mounted in the evaporation chamber at an angle relative to the crucible such that evaporated material approaches the glass plates at an oblique angle relative to an axis extending normal to each glass plate. However, evaporated material at varying radial distances from the center of each glass will approach and deposit on the glass plates at different angles relative to normal, thus creating variations or non-uniformities in the pre-tilt alignment layers.

As shown in FIG. 2, the angles of deposition influence the pre-tilt angle a, at which a liquid-crystal molecule adjacent the substrate will be oriented in the absence of an electric field between the electrodes. The existing design and manufacturing objective is to make the pre-tilt angle as uniform as possible across the substrates. Variations in the pre-tilt angle a across a substrate can degrade LCD quality by causing a non-uniform contrast ratio, resulting in a LCD that lacks the ability to display a uniformly-illuminated image. When the liquid-crystal molecules are oriented at different angles at the substrates, polarized light transmitted through the liquid-crystal material will experience differences in birefringence at different locations in the X-Y plane. The pre-tilt angles a defined by the alignment layer at each substrate must be uniform across the planar surface in the X-Y plane of each substrate to minimize variations in brightness.

Another method of forming alignment layers involves rubbing to physically and uniformly align projections on the alignment layers in a desired direction. Disadvantages of this method are accumulation of static electricity and contamination. Other methods use evaporation of SiO films on glass plates followed by additional treatment with surfactants to introduce uniform pre-tilt angles a. With these methods it is difficult to control the pre-tilt angle a to an arbitrary value across a wide range as needed for large LCDs. Each of these shortcomings has impeded wide-spread acceptance of VAN LCDs as a preferred type of display. There are no other known solutions to the problem of non-uniform pre-tilt other than to minimize or eliminate it.

Another method provides a controlled high-tilt-angle (0-60°) nematic alignment by an oblique evaporation procedure without the use of organic surfactants or dopants, by changing the azimuth of the SiO beam during evaporation to control the tilt bias of the director to achieve uniform homeotropic and tilted homeotropic alignment. The azimuth of the SiO beam is changed continuously during evaporation to control the tilt bias of the director. Although this method can produce the described pre-tilt angle ranges, it is difficult to control within the required parameters in practice.

Accordingly, there is a need in the art for a VAN LCD with a high contrast ratio, wide viewing angle and a rapid response time in a cell that can be easily manufactured.

### SUMMARY OF THE INVENTION

The invention provides a VAN LCD with an enhanced contrast ratio with a rapid switching time, and a method for its manufacture. A first alignment layer is provided on a first substrate to define first substrate pre-tilt angles. A second alignment layer is provided on a second substrate to define second substrate pre-tilt angles which are complementary to the first substrate pre-tilt angles. Average values of the first substrate pre-tilt angles and the second substrate pre-tilt angles are generally uniform.

A VAN LCD is formed by a process comprising the steps of placing a first substrate in an evaporation chamber at a first deposition angle and depositing evaporated material onto a surface of the first substrate to form an alignment layer that defines pre-tilt angles between first-substrate normal and molecules of a liquid-crystal fluid located adjacent to the surface of the first substrate; and positioning a second substrate within the evaporation chamber at a second deposition angle, wherein the first and second deposition angles are substantially the same, and depositing evaporated material onto a surface of the second substrate to form an alignment layer that defines pre-tilt angles between second substrate normal and molecules of the liquid crystal fluid located adjacent to the surface of the second substrate. The first substrate is positioned parallel to the second substrate such that the first and second alignment layers are facing. The second substrate is rotated about 180° in a plane of the second substrate relative to the first substrate, so the pre-tilt angles of the first and second alignment layers are complementary, that is, the pre-tilt angles of the first and second alignment layers are aligned across the width of the cell such that the pre-tilt effects of each are averaged to substantially negate or cancel the other to increase switching speed.

In accordance with another aspect of the invention, a method of forming VAN LCD cells includes the steps of depositing an alignment layer onto a surface of a first substrate for defining first pre-tilt angles associated with the first substrate, and depositing an alignment layer onto a surface of a second substrate for defining second pre-tilt angles associated with the second substrate. The first substrate is positioned parallel to the second substrate with the first and second alignment layers facing. Averages of the first and second pre-tilt angles of the first and second alignment layers are generally uniform.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is an illustrative arrangement of an oblique evaporation assembly;

FIG. 2 is a cross section of a conventional LCD substrate of the prior art with an alignment layer with uniform pre-tilt angles;

FIG. 3 is a schematic cross section of a LCD wherein the alignment layers of the opposing substrates define varying pre-tilt angles, and wherein the pre-tilt angles of the opposing alignment layers are complementary, and

FIG. 4 is a flow chart of steps in a manufacturing method of the invention.

### DETAILED DESCRIPTIONS OF PREFERRED AND ALTERNATE EMBODIMENTS

Certain terminology is used herein for convenience only and is not to be taken as a limitation on the present invention. Further, in the drawings, certain features may be shown in schematic form.

FIG. 3 shows a schematic cross section of a vertically-aligned nematic liquid-crystal display (“LCD”) 10 according to an embodiment of the present invention. As shown, the LCD 10 includes a first substrate 12, a second substrate 15 spaced apart from and oriented generally parallel to the first substrate 12, and a liquid-crystal fluid 18 having a negative dielectric anisotropy disposed between the first and second substrates 12, 15. A first alignment layer 21 is provided to an interior surface 23 of the first substrate 12 for generating first-substrate pre-tilt angles α₁ between first-substrate normal 26 and molecules 29 of the liquid-crystal fluid 18 that are located adjacent to the interior surface 23 of the first substrate 12. Similarly, a second alignment layer 32 is provided to an interior surface 35 of the second substrate 15 for generating second-substrate pre-tilt angles a₂ between second-substrate normal 37 and molecules 29 of the liquid-crystal fluid 18 located adjacent to the interior surface 35 of the second substrate 15. An average value of the first and second pre-tilt angles α₁, α₂ of the LCD 10 located along a common axis 39 that extends normal to the first and second substrates 12, 15 is generally uniform across the LCD. That is, the average value of α₁ and α₂ located the common axis 39 is substantially the same or uniform irrespective of axis 39 normal to substrates 12, 15. For example, at a particular axis through the LCD, such as A, where the pre-tilt angle al is 6 degrees, and the pre-tilt angle α2 is 0 degrees, the average pre-tilt angle is 3 degrees. The average pre-tilt angle is reduced by the alignment of complementary pre-tilt angles. As used herein, the terms “complementary” and “complementary alignment” refer to the matching or alignment of a first pre-tilt angle on a first alignment layer with a second pre-tilt angle on a second alignment layer, wherein the first pre-tilt angle is different from, e.g. greater than or less than, the second pre-tilt angle, and vice versa, to achieve the effect of substantially negating or offsetting the other or to otherwise achieve a reduced average pre-tilt angle between the two alignment layers. In this way, light traveling longitudinally along axis 39 experiences generally the same birefringence at each location across the LCD 10 with the molecules 29 oriented vertically, thereby establishing a uniform brightness across the LCD 10 with the LCD 10 in an “off” state.

Other common and well-known features of the LCD such as electrodes, color filters, electronic circuitry, individual pixels and the like have been omitted from the figures to clearly illustrate exemplary embodiments of the present invention. Such features are well known in the art and can be included as necessary in LCDs which embody the principles of the invention by those of ordinary skill in the art.

The first and second substrates 12, 15 can be formed from polarized glass that will linearly polarize circularly-polarized and unpolarized light. Each substrate 12, 15 of polarized glass has a polarization axis which is parallel to a plane of oscillation of light that is allowed to pass through the respective substrates 12, 15. Accordingly, circularly-polarized and unpolarized light incident to one of the substrates 12, 15 will be polarized into light having a single plane of oscillation that is parallel to the polarization axis of the respective substrate 12, 15 through which it passes. Although illustrated and described herein as a transmissive LCDs, the principles of the invention are also applicable to reflective LCDs.

When the LCD 10 is assembled, the polarization axis of each substrate 12, 15 is oriented perpendicular to the polarization axis of the other substrate 12, 15. One or more spacers are provided to separate the substrates 12, 15 and maintain their parallel positions. The void between the first and second substrates 12, 15 houses the liquid-crystal fluid 18, which can be a nematic liquid crystal fluid 18, and can have a negative dielectric anisotropy.

A nematic liquid-crystal fluid 18 is a transparent or translucent liquid that changes the polarization of the linearly-polarized light as the light is transmitted through the liquid. More specifically, the nematic liquid-crystal fluid 18 adjusts the angular orientation of the polarized-light's plane of oscillation as the light is transmitted through the fluid 18. The extent of the adjustment depends on the intensity of an electric field applied to the electrodes of the LCD 10, which, in turn, varies the orientation of the LC molecules 29 within the bulk fluid accordingly.

The liquid-crystal fluid 18 may have a negative dielectric anisotropy. The negative dielectric anisotropy of the liquid-crystal fluid 18 causes the liquid-crystal molecules 29, which are aligned generally vertically according to the directions established by the alignment layers 21, 32 in the absence of an electric field to align generally horizontally along their azimuthal directions when a suitable electric field is applied between the electrodes. Varying the intensity of the electric field can align the molecules 29 in orientations between the generally-vertical and generally-horizontal positions.

To promote uniform, controlled movement of the liquid-crystal molecules 29 from the off state to the on state across the LCD, the alignment layers 21, 32 on each of the substrates 12, 15 establishes the pre-tilt angles α₁, α₂ between substrate normal and the liquid-crystal molecules 29 adjacent to the substrates 12, 15. Nematic liquid-crystal molecules 29 between the liquid-crystal molecules 29 adjacent to the substrates 12, 15 naturally align themselves in an ordered pattern relative to neighboring molecules 29. The pre-tilt angles α₁, α₂ defined by the alignment layers 21, 32 provide a preferential direction of movement for the liquid-crystal molecules 29 in the presence of an electric field. For example, a liquid-crystal molecule 29 that is perfectly orthogonal to the substrates 12, 15 would theoretically reorient itself in an unpredictable direction in the presence of an electric field that is also perfectly orthogonal to the substrates 12, 15. In contrast, a liquid-crystal molecule forming a pre-tilt angle α₁, α₂ relative to substrate normal 26, 37 can be predicted to “fall” or otherwise orient itself along its azimuthal direction in the generally-horizontal position in the presence of an electric field. Thus, a force applied to the liquid-crystal molecules 29 of the present invention when a suitable potential difference is applied to the electrodes forces the liquid-crystal molecules 29 into their desired horizontal position aligned with their respective azimuthal directions.

The first alignment layer 21 is formed on an interior surface 23 of the first substrate 12 to define first-substrate pre-tilt angles α₁ between first-substrate normal 26 and molecules 29 of the liquid-crystal fluid 18 that are located adjacent to the interior surface 23 of the first substrate 12. The interior surface 23 is the surface of the first substrate 12 that faces the second substrate 15 when the LCD is assembled, and forms a boundary of the cavity between the first and second substrates 12, 15.

The second alignment layer 32 is formed on an interior surface 35 of the second substrate 15 to define second-substrate pre-tilt angles a2 between second-substrate normal 37 and molecules 29 of the liquid-crystal fluid 18 located adjacent to the interior surface 35 of the second substrate 15. The interior surface 35 is the surface of the second substrate 15 that faces the first substrate 12 when the LCD is assembled, and forms a boundary of the cavity between the first and second substrates 12, 15.

The alignment layers 21, 32 can be formed from any suitable material that can control alignment of liquid-crystal molecules 29 adjacent to the respective substrates 12, 15. Examples of suitable materials include: SiO, SiO₂, CaF₂, Al₂O₃ and MgF₂.

Uniformity of the pre-tilt angles α₁, α₂ for each individual substrate 12, 15 is not necessarily required. Each alignment layer 21, 32 can define a plurality of different pre-tilt angles α₁, α₂. However, regardless of whether pre-tilt angles α₁, α₂ are uniform or varying for each substrate 12, 15 of the LCD 10, pre-tilt angles α₁, α₂ located along a common axis 39 normal to the assembled-LCD substrates 12, 15 will have generally the same average value as pre-tilt angles α₁, α₂ located along another common axis normal to the substrates 12, 15 elsewhere in the XY plane of the LCD 10. This is true regardless of the location of the common axes 39 between the substrates 12, 15 of the LCD 10.

For example, one vertical axis 39 that is orthogonal to the substrates 12, 15 of the assembled LCD 10, the numerical average of the pre-tilt angle α₁ₐ and the pre-tilt angle α₂ₐ is a number represented by P degrees. For another vertical axis 39 extending between the substrates 12, 15 at another location in the XY plane of the LCD 10, the numerical average of the pre-tilt angle α_{1b} and the pre-tilt angle α_{2b} is also about P degrees. Hence, the average value of pre-tilt angles α₁, α₂ located along common axes orthogonal to the substrates 12, 15 is generally uniform. By providing a generally-uniform average pre-tilt angle α₁, α₂ for vertical axes 39 that extend between, and orthogonal to the substrates 12, 15 of the LCD 10, the LCD 10 is provided with a consistent brightness and large contrast ratio.

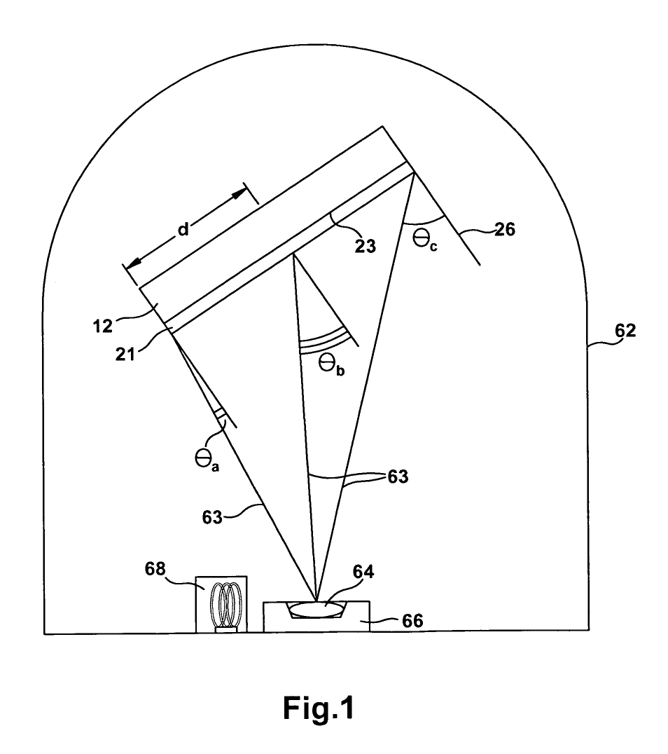

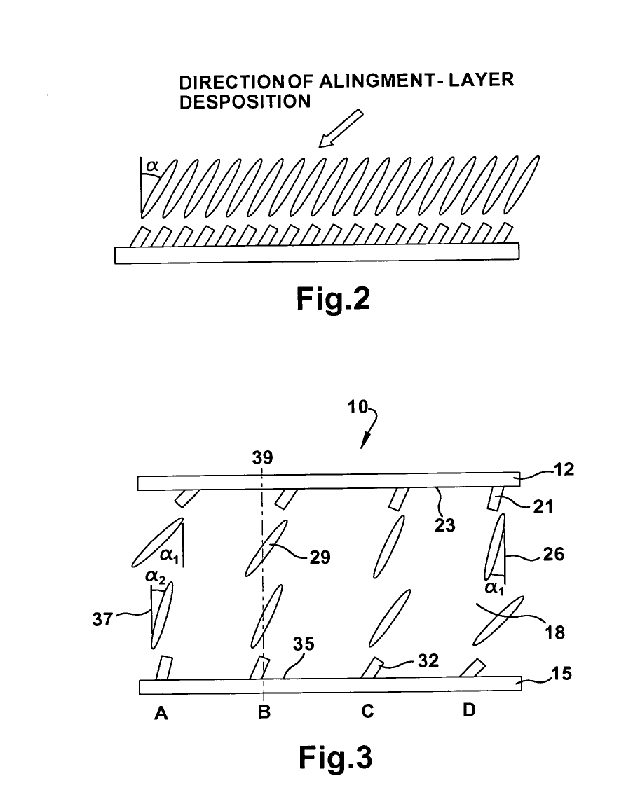

The LCD of the present invention can be formed by a process that does not necessarily result in the formation of uniform pre-tilt angles α₁, α₂ across each substrate 12, 15. Referring to FIG. 1, a step of the simplified process includes positioning a first substrate 12 within an evaporation chamber 62 to form a plurality of different deposition angles θₐ, θ_{b}, θ_{c} between first-substrate normal 26 and direct evaporation paths 63 between the alignment-layer material 64 and the intersection of the first-substrate normal 26 with the first substrate 12. The alignment-layer material 64 can be held within a crucible 66, from which it can evaporate upon being subjected to energy from an electron gun, or other energy source 68. The deposition angle θ varies based on the distance d of first-substrate normal 26 from the center of the substrate 12. For instance, deposition angle θₐ is different than deposition angle θ_{b}. The distance between the alignment-layer material 64 and the substrate 12 is not sufficiently large when compared to the dimensions, such as the diameter, of the substrate 12 to neglect the variations in the deposition angle θ.

Another step includes depositing evaporated alignment-layer material 64 onto a surface 23 of the first substrate 12 at the deposition angles θ relative to the alignment-layer material 64. This deposition step results in the formation of a first alignment layer 21 that can define pre-tilt angles between first-substrate normal 26 and molecules of a liquid-crystal fluid that are located adjacent to the surface 23 of the first substrate 12. Embodiments of the present invention include deposition angles θ that fall within a range of about 0 degrees to about 90 degrees.

The steps described above, are repeated for the second substrate 15 and include positioning a second substrate 15 within the evaporation chamber 62 and depositing the alignment-layer material 64 onto a surface 35 of the substrate 15. As with the first substrate, a deposition angle θ is formed between second-substrate normal and a direct-evaporation path from the alignment-layer material 64, and the deposition angles θₐ, θ_{b}, θ_{c} of the second substrate 15 also vary with their position on the substrate. However, the second substrate 15 is positioned within the evaporation chamber in a complementary manner such that the deposition angles θ formed for the second substrate 15 are substantially the same as those formed for the first substrate 12. Small variations are tolerable so long as the contrast ratio of the resulting LCD 10 does not vary significantly. This can be accomplished by removing the first substrate 12 from the evaporation chamber 62 following the deposition step and placing the second substrate 15 in the same location as the first substrate 12 within the evaporation chamber as a two-step process, or by symmetrically positioning both the first and second substrates 12, 15 within the evaporation chamber 62 at the same time relative to the position of the alignment-layer material 64, or any other method that will result in the formation of the same or substantially the same deposition angles θₐ, θ_{b}, θ_{c}.

Once the second substrate 15 is properly positioned within the deposition chamber, the process further includes the step of depositing evaporated material onto a surface 35 of the second substrate 15 to form an alignment layer 32 that can define pre-tilt angles α₂ between second-substrate normal 37 and molecules 29 of the liquid-crystal fluid 18 located adjacent to the surface 35 of the second substrate 15.

The first substrate 12 provided with the alignment layer 21 is placed adjacent, and substantially parallel to the second substrate 32, wherein the surfaces 23, 35 of the first and second substrates 12, 15 on which the evaporated material was deposited are facing inwardly, i.e., facing each other. One of the first and second substrates 12, 15 rotated relative to the other, about a central, substrate-normal axis approximately 180° in either a clockwise or counterclockwise direction in the plane of the substrate. Thus, when a liquid-crystal fluid 18 is inserted into the cavity between the first and second substrates 12, 15, a plurality of different pre-tilt angles α₁, α₂ is defined by each of the alignment layers 21, 32. However, the liquid-crystal molecules 29 adjacent to each substrate 12, 15 exhibit an anti-parallel alignment, and pairs of pre-tilt angles α₁, α₂ aligned along common vertical axes 39 that are orthogonal to the substrates 12, 15 have a generally-uniform average value, regardless of the location of the vertical axis in the XY plane of the substrates 12, 15.

The LCD formed by the process described above includes first and second pre-tilt angles α₁, α₂ located along common normal axes 39 relative to the first and second substrates that, when averaged, are generally constant regardless of the location of the normal axes in the XY plane of the LCD 10. Embodiments include a generally-constant average pre-tilt angle within a range of about 1° to about 20°, including embodiments having an average pre-tilt angle in the range of 1-10 degrees. Absolute values of the pre-tilt angles α₁, α₂ are used to calculate the average values discussed herein.

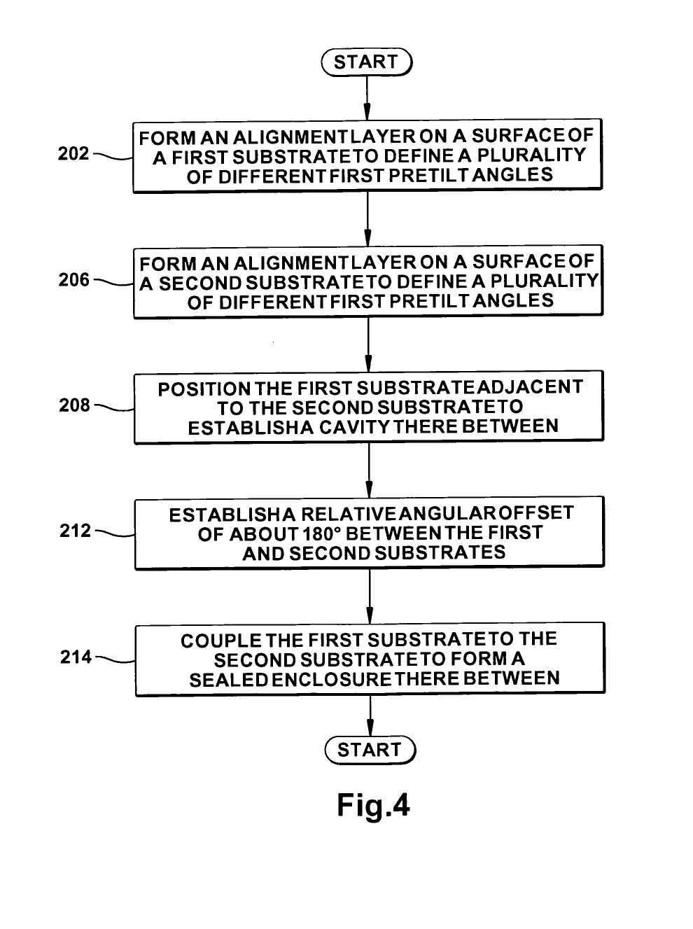

A method of forming a vertically-aligned nematic liquid-crystal display with complementary alignment layers is generally outlined in FIG. 4. Although illustrated in FIG. 4 in the form of a flow diagram, the process is not limited to the particular order in which the steps are listed. The steps include forming an alignment layer 21 on a surface 23 of a first substrate 12 to define pre-tilt angles a, between first-substrate normal 26 and molecules 29 of a liquid-crystal fluid 18 located adjacent to the surface 23 of the first substrate 12 at step 202, and forming an alignment layer 32 on a surface 35 of a second substrate 15 to define pre-tilt angles a2 between second-substrate normal 37 and molecules 29 of a liquid-crystal fluid 18 located adjacent to the surface 35 of the second substrate 15 at step 206. The alignment layers 21, 32 can be formed on each of the first and second substrates by evaporating, or otherwise depositing alignment-layer material 64 that has been fluidized onto the appropriate surface 23, 35 of the substrates 12, 15. Other suitable methods for forming the alignment layers 21, 32 can include coating processes, and any other method that can form alignment layers 21, 32 that define pre-tilt angles α₁, α₂. For instance, evaporating the alignment-layer material 64 at an oblique angle relative to the surface 23, 35 of the substrates 12, 15 on which the material 64 is to be deposited can define suitable pre-tilt angles α₁, α₂, which can vary over the surface 23, 35 of each substrate 12, 15.

Formation of the cavity in which a liquid-crystal fluid 18 is to be placed can be accomplished at step 208 by placing the first substrate 12 adjacent, and substantially parallel to the second substrate 15, wherein the surface 23, 35 of the first and second substrates 12, 15 on which the alignment layer 21, 32 is to be deposited are facing inwardly, i.e., into the cavity defined between the substrates 12, 15 and facing each other. A liquid-crystal fluid 18 having a negative dielectric anisotropy is to be provided between the first and second substrates 12, 15, which are to be positioned so averages of the pre-tilt angles α₁, α₂ defined by the alignment layer 21, 32 provided to the first and second substrates 12, 15 and located along common axes 39 that extend normal to the first and second substrates 12, 15 are substantially uniform for the LCD 10. Embodiments of the present invention include generally-uniform averages of the pre-tilt angles α₁, α₂ of the LCD 10 within a range from about 0 degrees to about 20 degrees relative to the common axes 39, which are normal to the substrates 12, 15, including any numerical value within that range. The cavity between the substrates 12, 15 can be sealed at step 214 to form a complete enclosure about the liquid-crystal fluid 18.

Positioning the first and second substrates 12, 15 at step 212 optionally comprises rotating at least one of the first and second substrates 12, 15 to establish a relative angular offset of about 180° in a plane of the rotated substrates 12, 15. By rotating at least one of the substrates 12, 15 to this degree, the molecules 29 adjacent to the surfaces 23, 35 of the first and second substrates 12, 15 provided with the alignment layer 21, 32 exhibit a complementary anti-parallel alignment.

Although described with reference to certain embodiments and examples, the disclosed principles and concepts may be executed in other manners which are nonetheless within the literal and equivalent scope of the claims.

What is claimed is:

1. A vertically-aligned nematic liquid-crystal display comprising:
a first substrate;
a second substrate spaced from and generally parallel to the first substrate;
a liquid-crystal fluid between the first and second substrates;
a first alignment layer on an interior surface of the first substrate for defining a plurality of different first-substrate pre-tilt angles between first-substrate normal and molecules of the liquid-crystal fluid located adjacent to the interior surface of the first substrate; and
a second alignment layer on an interior surface of the second substrate for defining a plurality of different second-substrate pre-tilt angles between second-substrate normal and molecules of the liquid-crystal fluid located adjacent to the interior surface of the second substrate, wherein
an average value of the first-substrate and second-substrate pre-tilt angles located along a common axis that extends normal to the first and second substrates is substantially the same as an average value of the first-substrate and second substrate pre-tilt angles located along another common axis that extends normal to the first and second substrates.

2. The liquid-crystal display according to claim 1, wherein the common axes intersect a plane parallel to the first and second substrates at different locations.

3. The liquid-crystal display according to claim 1, wherein the average value of the pre-tilt angles located along the common axes has a value within a range of from about 1 degrees to about 10 degrees.

4. The liquid-crystal display according to claim 1, wherein the first-substrate and second-substrate pre-tilt angles are generally anti-parallel.

5. The liquid-crystal display according to claim 1, wherein the alignment layer is formed from a material selected from the group consisting of SiO, SiO₂, CaF₂, Al₂O₃ and MgF₂.

6. A vertically-aligned nematic liquid-crystal display cell formed by a process comprising the steps of:
positioning a first substrate within an evaporation chamber at a first deposition angle;
depositing evaporated alignment-layer material onto a surface of the first substrate to form an alignment layer that can define pre-tilt angles between first-substrate normal and molecules of a liquid-crystal fluid located adjacent to the surface of the first substrate;
positioning a second substrate within the evaporation chamber at a second deposition angle, wherein the first and second deposition angles are substantially the same;
depositing evaporated alignment-layer material onto a surface of the second substrate to form an alignment layer that defines pre-tilt angles between second-substrate normal and molecules of the liquid-crystal fluid located adjacent to the surface of the second substrate;
placing the first substrate adjacent, parallel and facing the second substrate; and
rotating the second substrate approximately 180 degrees in a plane of the second substrate relative to the first substrate to a final assembly position of the first and second substrates of the liquid crystal cell.

7. The liquid-crystal display cell according to claim 6, wherein the process further comprises the step of providing the liquid-crystal fluid having a negative dielectric anisotropy between the first and second substrates.

8. The liquid-crystal display cell according to claim 6, wherein the first and second deposition angles are within a range from about 0 degrees to about 90 degrees.

9. The liquid-crystal display cell according to claim 6, wherein an average of the first and second pre-tilt angles located along a first normal axis relative to the first and second substrates is substantially the same as an average of the first and second pre-tilt angles located along a second normal axis relative to the first and second substrates.

10. The liquid-crystal display cell according to claim 9, wherein the average of the first and second pre-tilt angles is within a range of about 0 degrees to about 20 degrees.

11. A method of forming a vertically-aligned nematic liquid-crystal display, the method comprising the steps of:
depositing an alignment layer onto a surface of a first substrate for defining pre-tilt angles between first-substrate normal and molecules of a liquid-crystal fluid located adjacent to the surface of the first substrate;
depositing an alignment layer onto a surface of a second substrate for defining pre-tilt angles between second-substrate normal and molecules of the liquid-crystal fluid located adjacent to the surface of the second substrate;
placing the first substrate adjacent and parallel to the second substrate, with the first and second substrates facing;
providing a liquid-crystal fluid between the first and second substrates; and
positioning the first and second substrates so that averages of the pre-tilt angles defined by the alignment layer provided to the first and second substrates and located along common axes that extend normal to the first and second substrates are generally uniform.

12. The method according to claim 11, wherein the steps of depositing the material onto the first and second substrates comprises the step of:
evaporating the material at an oblique angle relative to the surface of the substrate on which the material is to be deposited.

13. The method according to claim 12, wherein the oblique angle is within a range of about 0 degrees to about 90 degrees.

14. The method according to claim 11, wherein the evaporated material is selected from the group consisting of SiO, SiO₂, CaF₂, Al₂O₃, and MgF₂.

15. The method according to claim 11, wherein the generally-uniform averages of the pre-tilt angles located along common axes are within a range of about 2 degrees to about 5 degrees relative to the common axes.

16. The method according to claim 11, wherein the step of positioning the first and second substrates comprises the step of:
offsetting the relative angular position of the first and second substrates by about 180° in a plane parallel to the substrates.

17. The method according to claim 11, wherein the liquid-crystal fluid has a negative dielectric anisotropy.

18. A vertically-aligned nematic liquid crystal cell comprising:
a first substrate;
a second substrate spaced from the first substrate;
the first substrate having a first alignment layer configured to establish a plurality of first pre-tilt angles;
the second substrate having a second alignment layer configured to establish a plurality of second pre-tilt angles which are complementary to the first pre-tilt angles.
